(19) United States
(12) Patent Application Publication
(10) Pub. No.: US 2026/0300340 A1
(43) Pub. Date: Oct. 1, 2026

(54) INFORMATION PROCESSING APPARATUS, NOTIFICATION METHOD, AND NON-TRANSITORY COMPUTER-READABLE MEDIUM

(71) Applicant: NEC Corporation, Tokyo (JP)

(72) Inventors: Daisuke Matsuda, Tokyo (JP); Shintaro Soma, Tokyo (JP); Muneyuki Hamabe, Tokyo (JP)

(73) Assignee: NEC Corporation, Tokyo (JP)

(21) Appl. No.: 19/629,238

(22) Filed: Mar. 26, 2026

(30) Foreign Application Priority Data
Mar. 31, 2025 (JP) 2025-057451

(51) Int. Cl. G06F 16/3329; G06Q 10/0635

(52) U.S. Cl. CPC G06F 16/33295; G06Q 10/0635

(57) ABSTRACT

To facilitate monitoring of various matters having a possibility of affecting the management environment of a company. An information processing apparatus includes a related information acquisition unit for acquiring related information related to a company to be a target, a prompt generation unit for generating a prompt inquiring about a matter having a possibility of affecting a management environment of the company by using the related information, a generation control unit for inputting the prompt to a machine-learned generative model to generate an answer, and a notification unit for notifying a matter having a possibility of affecting the management environment of the company based on the answer. Furthermore, according to the information processing apparatus, decision-making regarding management of a company can be supported.

### SPECIFICATION

### INCORPORATION BY REFERENCE

This application is based upon and claims the benefit of priority from Japanese patent application No. 2025-057451, filed on Mar. 31, 2025, the disclosure of which is incorporated herein in its entirety by reference.

### TECHNICAL FIELD

The present disclosure relates to an information processing apparatus, a notification method, and a notification program.

### BACKGROUND ART

In the management of a company, it is required to continuously monitor various matters having a possibility of affecting the management environment, and if matters to be handled occur, to promptly handle the matters. For example, in a case where laws and regulations related to the business of a company are revised, it may be necessary to review the business contents in such a way as not to violate the revised laws and regulations. As a technique for facilitating such a measure, for example, there is a regulation revision notification system described in JP 2010-191657 A.

In the regulation revision notification system described in JP 2010-191657 A, regulation data acquired via an Internet line is accumulated in a mass storage device, the regulation data acquired last and the regulation data acquired the previous time are compared to detect a mismatch portion and create the regulation revision data. Then, the user terminal is notified of the revision of the regulation based on the regulation revision data.

### SUMMARY

The regulation revision notification system described in JP 2010-191657 A is specialized in detection and notification of the regulation revision, and there is room for improvement in terms of extendibility. For example, in the management of a company, it is required to be sensitive to a change in the management state of a business partner, a change in the trend of the entire industry, and the like in addition to the revision of the regulation, but the regulation revision notification system described in JP 2010-191657 A cannot make the user aware of such a change.

The present disclosure has been made in view of the above problems, and an example object thereof is to provide a technique for facilitating monitoring of various matters having a possibility of affecting the management environment of a company.

An information processing apparatus according to an example aspect of the present disclosure includes a related information acquisition means for acquiring related information related to a company to be a target, a prompt generation means for generating a prompt inquiring about a matter having a possibility of affecting a management environment of the company by using the related information, a generation control means for inputting the prompt to a machine-learned generative model to generate an answer, and a notification means for notifying a matter having a possibility of affecting the management environment of the company based on the answer.

A notification method according to an example aspect of the present disclosure, by at least one processor, includes related information acquisition processing of acquiring related information related to a company to be a target, prompt generation processing of generating a prompt inquiring about a matter having a possibility of affecting a management environment of the company by using the related information, generation control processing of inputting the prompt to a machine-learned generative model to generate an answer, and notification processing of notifying a matter having a possibility of affecting the management environment of the company based on the answer.

A notification program according to an example aspect of the present disclosure for causing a computer to function as a related information acquisition means for acquiring related information related to a company to be a target, a prompt generation means for generating a prompt inquiring about a matter having a possibility of affecting a management environment of the company by using the related information, a generation control means for inputting the prompt to a machine-learned generative model to generate an answer, and a notification means for notifying a matter having a possibility of affecting the management environment of the company based on the answer.

According to an example aspect of the present disclosure, an exemplary effect is obtained in that a technique that facilitates monitoring of various matters having a possibility of affecting the management environment of a company can be provided.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a block diagram illustrating a configuration of an information processing apparatus according to the present disclosure;

FIG. 2 is a flowchart illustrating a flow of a notification method according to the present disclosure;

FIG. 3 is a block diagram illustrating a configuration of another information processing apparatus according to the present disclosure;

FIG. 4 is a diagram illustrating an example of notification by the information processing apparatus illustrated in FIG. 3;

FIG. 5 is a diagram illustrating an example of a notification screen listing matters having a possibility of affecting the management environment of a target company;

FIG. 6 is a diagram showing an example of a notification screen showing details of a matter having a possibility of affecting the management environment of the target company;

FIG. 7 is a view illustrating a presentation example of related current event information on a notification screen;

FIG. 8 is a diagram illustrating an example of answer generation using additional related information;

FIG. 9 is a flowchart illustrating a flow of processing executed by the information processing apparatus illustrated in FIG. 3;

FIG. 10 is a flowchart of processing related to monitoring of the management environment; and

FIG. 11 is a block diagram illustrating a configuration of a computer that functions as the information processing apparatus according to the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not have the effects mentioned in each of the exemplary example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described later. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in other exemplary example embodiments included in the present disclosure within a range in which no particular technical problem occurs.

### Configuration of Information Processing Apparatus 1

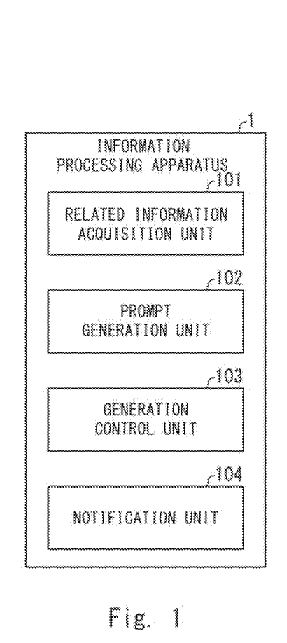

A configuration of an information processing apparatus 1 according to the present exemplary example embodiment will be described with reference to FIG. 1. FIG. 1 is a block diagram illustrating the configuration of the information processing apparatus 1. As illustrated in FIG. 1, the information processing apparatus 1 includes a related information acquisition unit 101, a prompt generation unit 102, a generation control unit 103, and a notification unit 104.

The related information acquisition unit 101 acquires related information related to a company to be the target (hereinafter, also referred to as a target company). A method for acquiring related information may be any method. For example, the related information acquisition unit 101 may acquire the related information input by the user of the information processing apparatus 1, or may acquire the related information by reading the related information stored in the information processing apparatus 1 or another apparatus.

What kind of company to set the target company is arbitrary. For example, the target company may be designated by the user or the like of the information processing apparatus 1. In addition, the “related information” may be of any form as long as it includes content related to the target company. For example, a document in which a business outline, a business partner, and the like of the target company are described, that is, text data may be set as the related information. In addition, for example, an Investor Relations (IR) material, a financial statement, a material indicating a management plan, and the like of the target company may be the related information. In a case where graphs, images, and the like are included in these materials, they may be used as the related information as they are, or may be converted into text data and then used as the related information. Conversion of an image or the like into text data can be performed using, for example, a Vision and Language Model (VLM) or the like. In addition, for example, action history information (e.g., history information of browsed article, etc.) of an employee or a manager of the target company may be used as the related information. The related information may include various types of information related to the industry type of the target company. For example, in a case where the target company is a medical institution, information such as a medical department, the number of patients that can be accommodated, the number of belonging medical workers, and main medical apparatuses held may be used as the related information.

The prompt generation unit 102 generates a prompt inquiring about a matter having a possibility of affecting the management environment of the target company by using the related information acquired by the related information acquisition unit 101. Here, the “prompt” is a statement to be input to a generative model to be described later. Therefore, it can be said that the prompt inquiring about the matter having a possibility of affecting the management environment of the target company is a statement instructing to answer for the matter having a possibility of affecting the management environment of the target company. For example, the prompt generation unit 102 generates, as the prompt, a sentence in a natural language including the related information and instructing to output a matter having a possibility of affecting the management environment of the company indicated in the related information. Such a prompt can be generated, for example, by incorporating related information into a predetermined template.

The generation control unit 103 inputs the prompt generated by the prompt generation unit 102 to the machine-learned generative model to generate an answer. The “generative model” may be machine-learned in such a way as to be able to output an answer related to an input prompt. In addition, what kind of generative model to use may be determined according to what kind of data format related information is input to the generative model, what kind of data format answer is to be generated, and the like. For example, in a case where both the input prompt and the answer to be output are text data of a natural language, a language model that has learned a natural language may be applied as the generative model. Learning a natural language more specifically means learning an arrangement of components (words etc.) in a sentence in a natural language or an arrangement of a sentence and a sentence in writing. Examples of such a language model include, for example, Bidirectional Encoder Representations from Transformers (BERT), Robustly optimized BERT approach (RoBERTa), Efficiently Learning an Encoder that Classifies Token Replacements Accurately (ELECTRA), and the like. In addition, for example, in a case where a prompt including image data and text data is input, the above-described VLM or the like may be used as the generative model.

The above generative model may be stored in the information processing apparatus 1 or may be stored in another apparatus. In the latter case, the generation control unit 103 may transmit a prompt to another apparatus to generate an answer, and acquire the generated answer from the other apparatus.

The notification unit 104 notifies a matter having a possibility of affecting the management environment of the target company based on the answer generated by the generative model under the control of the generation control unit 103. Here, “notification” means a state in which the subject of the notification can recognize the notification content. For example, the notification unit 104 can make a notification by causing the output device to output the notification content. Furthermore, for example, the notification unit 104 can make the notification by having the notification content browsable by the subject (e.g., upload the notification content to a server accessible by the subject). In addition, the notification based on the answer generated by the generative model includes directly notifying the answer generated by the generative model, and also includes extracting and notifying a part of the answer or processing and notifying the answer.

The subject of the notification is arbitrary. For example, in a case where the target company is designated by the user of the information processing apparatus 1, the user may be notified of the above matter. A notification mode is optional. For example, the notification unit 104 may notify the matter to the subject by causing the matter to be output to a terminal device used by the subject of the notification. An output mode is also optional, and for example, the notification unit 104 may notify the matter to the subject by any one of voice output, display output, and print output or a combination of a plurality of them.

As described above, the information processing apparatus 1 according to the present exemplary example embodiment adopts a configuration including the related information acquisition unit 101 for acquiring related information related to a company to be the target, the prompt generation unit 102 for generating a prompt inquiring about a matter having a possibility of affecting the management environment of the company by using the acquired related information, the generation control unit 103 for inputting the generated prompt to the machine-learned generative model to generate an answer, and the notification unit 104 for notifying the matter having a possibility of affecting the management environment of the company based on the generated answer.

According to the above configuration, a matter having a possibility of affecting the management environment of the company can be notified only by causing the information processing apparatus 1 to acquire related information related to a company to be the target. Therefore, according to the above configuration, an effect is obtained in that monitoring of various matters having a possibility of affecting the management environment of the company can be facilitated. Furthermore, according to the information processing apparatus 1, decision-making regarding management of a company can be supported.

### Notification Program

The functions of the information processing apparatus 1 described above can also be achieved by a program. A notification program according to the present exemplary example embodiment causes a computer to function as a related information acquisition means for acquiring related information related to a company to be the target, a prompt generation means for generating a prompt inquiring about a matter having a possibility of affecting the management environment of the company by using the acquired related information, a generation control means for inputting the generated prompt to the machine-learned generative model to generate an answer, and a notification means for notifying the matter having a possibility of affecting the management environment of the company based on the generated answer. According to the notification program, an effect is obtained in that monitoring of various matters having a possibility of affecting the management environment of the company can be facilitated.

### Flow of Notification Method

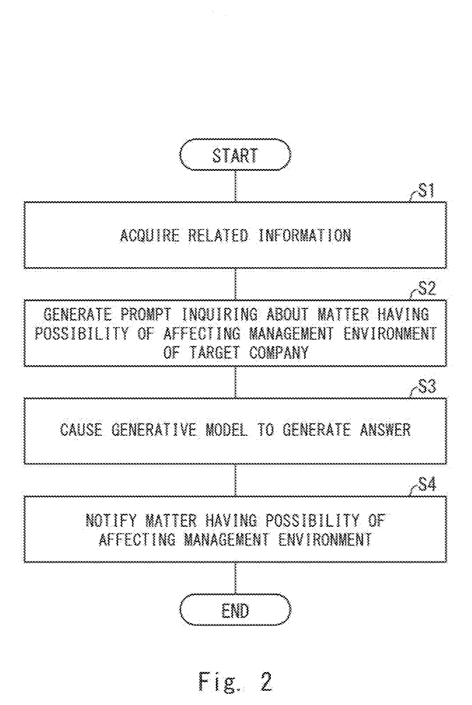

A flow of a notification method according to the present exemplary example embodiment will be described with reference to FIG. 2. FIG. 2 is a flowchart illustrating the flow of the notification method. An executing entity of each step in this notification method may be a processor included in the information processing apparatus 1, may be a processor included in another apparatus, or executing entities of each of the steps may be processors provided in different devices.

In S1 (related information acquisition processing), at least one processor acquires related information related to a company to be the target.

In S2 (prompt generation processing), at least one processor generates a prompt inquiring about a matter having a possibility of affecting the management environment of the company by using the related information acquired in S1.

In S3 (generation control processing), at least one processor inputs the prompt generated in S2 to the machine-learned generative model to generate an answer.

In S4 (notification processing), at least one processor notifies a matter having a possibility of affecting the management environment of the company based on the answer generated in S3.

As described above, the notification method according to the present exemplary example embodiment is a notification method of a conversion model adopting a configuration in which at least one processor includes related information acquisition processing of acquiring related information regarding a company to be the target, prompt generation processing of generating a prompt inquiring about a matter having a possibility of affecting the management environment of the company by using the acquired related information, a generation control processing of inputting the generated prompt to the machine-learned generative model to generate an answer, and a notification processing of notifying the matter having a possibility of affecting the management environment of the company based on the generated answer. Therefore, according to the notification method of the present example embodiment, an effect is obtained in that monitoring of various matters having a possibility of affecting the management environment of the company can be facilitated.

### Second Exemplary Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information Processing Apparatus 1A

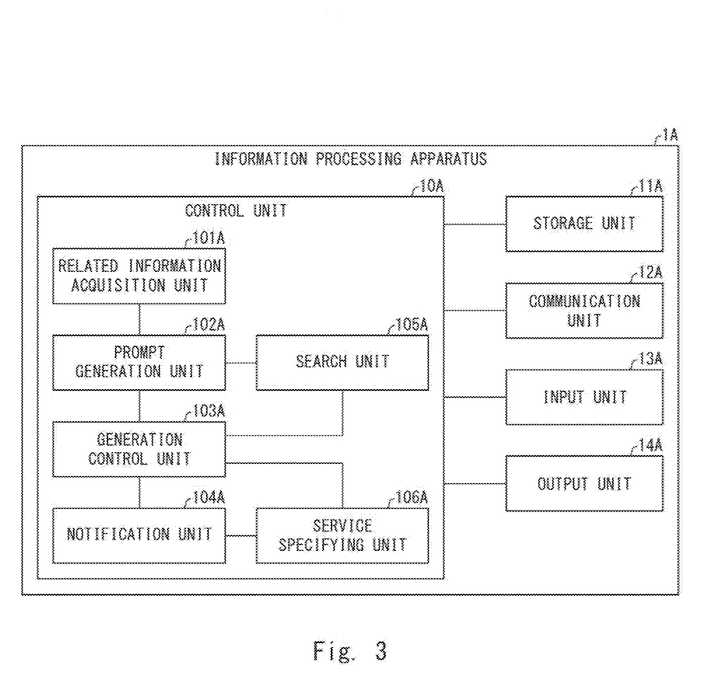

A configuration of an information processing apparatus 1A according to the present exemplary example embodiment will be described with reference to FIG. 3. FIG. 3 is a block diagram illustrating the configuration of the information processing apparatus 1A. The information processing apparatus 1A is a apparatus having a function of providing an information providing service that provides information regarding matters having a possibility of affecting the management environment of a company. The information processing apparatus 1A may be a local apparatus used by individual users, or may be a server that provides information providing services to a plurality of users.

As illustrated, the information processing apparatus 1A includes a control unit 10A for integrally controlling each unit of the information processing apparatus 1A and a storage unit 11A for storing various types of data used by the information processing apparatus 1A. The information processing apparatus 1A includes a communication unit 12A for the information processing apparatus 1A to communicate with another apparatus, an input unit 13A for accepting an input to the information processing apparatus 1A, and an output unit 14A for the information processing apparatus 1A to output data. The control unit 10A includes a related information acquisition unit 101A, a prompt generation unit 102A, a generation control unit 103A, a notification unit 104A, a search unit 105A, and a service specifying unit 106A.

The related information acquisition unit 101A acquires related information regarding the target company, similarly to the related information acquisition unit 101 of the first exemplary example embodiment. As described in the first exemplary example embodiment, the related information merely needs to include content related to the target company, and the form and the like thereof are arbitrary.

Similarly to the prompt generation unit 102 of the first exemplary example embodiment, the prompt generation unit 102A generates a prompt inquiring about a matter having a possibility of affecting the management environment of the target company by using the related information acquired by the related information acquisition unit 101A.

Similarly to the generation control unit 103 of the first exemplary example embodiment, the generation control unit 103A inputs a prompt generated by the prompt generation unit 102A to the machine-learned generative model to generate an answer. The generative model may be stored in the information processing apparatus 1A, or a generative model stored in another apparatus may be used. In the latter case, the generation control unit 103A transmits a prompt to the apparatus in which the generative model is recorded, and acquires an answer generated by the generative model from the apparatus.

Similarly to the notification unit 104 of the first exemplary example embodiment, the notification unit 104A notifies a matter having a possibility of affecting the management environment of the target company based on the answer generated by the generative model under the control of the generation control unit 103A. As described in the first exemplary example embodiment, the matter notified by the notification unit 104A is a part or all of the answer generated by the generative model or is that obtained by processing the answer.

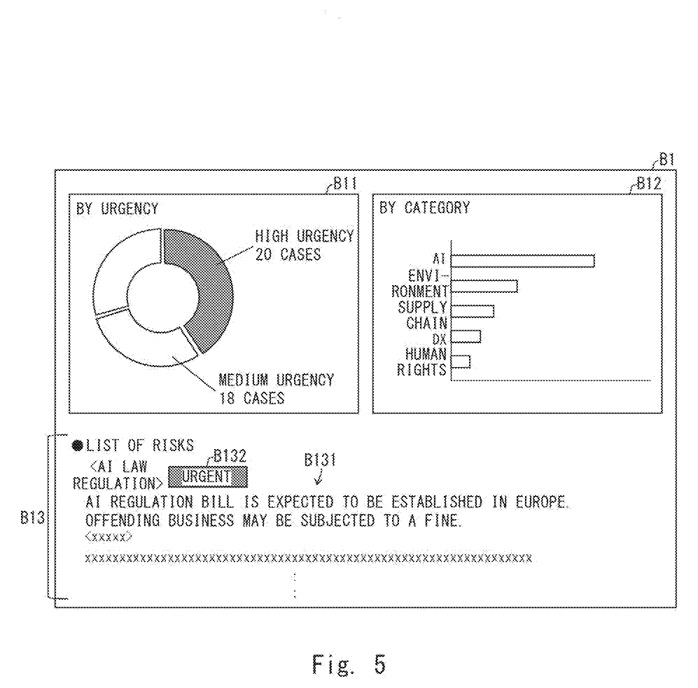

The processing of the answer may be performed by, for example, a generative model or another language model. For example, the notification unit 104A may notify a result of summarizing the answer generated by the generative model into a language model, or may notify a result of rewriting the answer generated by the generative model into a plainer expression by the language model. Furthermore, for example, the notification unit 104A may perform notification by generating and displaying a predetermined notification screen using the generated answer. The notification screen will be described later with reference to FIGS. 5-7.

The search unit 105A searches for information having a possibility of affecting the management environment of the target company. The information acquired by the search of the search unit 105A is used for generating an answer by the generative model. As a result, information that the generative model has not learned can be reflected in the answer generated by the generative model. Details of the search by the search unit 105A will be described later in the item “Regarding Search”.

A service specifying unit 106A specifies a service related to the matter indicated in the answer generated by the generative model (matter having a possibility of affecting the management environment of the target company) from a plurality of predetermined services. The plurality of predetermined services may be registered in advance. What kind of service to register is arbitrary. For example, it is conceivable to register a service for providing a means that deals with a change in the management environment that the target company is considered to encounter, a service for introducing an expert in dealing with a risk related to the target company, and the like. In addition, a method for specifying a related service is also arbitrary. For example, each service may be classified into any of a plurality of predetermined categories. In this case, a service specifying unit 106A may determine which category the matter indicated in the answer generated by the generative model belongs to, and specify the service in the same category as the category to which the matter belongs as the related service. A method of determining the category is arbitrary. For example, the category may be determined depending on whether the keyword defined for each category is included, the category may be determined by the language model, or the category may be determined using the feature vector of the answer generated by the generative model. For the generation of the feature vector, a conversion model obtained by machine learning in such a way as to convert the input data into the feature vector may be used.

As described above, the information processing apparatus 1A includes the related information acquisition unit 101A for acquiring related information related to a company to be the target, the prompt generation unit 102A for generating a prompt inquiring about a matter having a possibility of affecting the management environment of the target company by using the acquired related information, the generation control unit 103A for inputting the generated prompt to the machine-learned generative model to generate an answer, and the notification unit 104A for notifying the matter having a possibility of affecting the management environment of the target company based on the generated answer. Therefore, similarly to the information processing apparatus 1, an effect is obtained in that monitoring of various matters having a possibility of affecting the management environment of the target company can be facilitated.

### Regarding Search

As described above, the search unit 105A searches for information having a possibility of affecting the management environment of the target company. For example, the search unit 105A may perform a search targeting a database recording current event information, and may detect related current event information having a possibility of affecting the management environment of the target company. This makes it possible to notify about the matter related to current event. Here, the “current event information” is information regarding current events, that is, events occurring in the society at times. For example, a news article (which may be published as a moving image) published in a newspaper or an online medium, data obtained by coverage of a newspaper or the like, an explanatory article of news, a sentence, an image, or the like posted on a Social Networking Service (SNS) or the like are examples of current event information.

The information (e.g., the related current event information described above) detected by the search unit 105A is used for generating an answer by the generative model. Therefore, from the viewpoint of causing the generative model to generate a highly reliable answer, it is desirable to set a database in which highly reliable information is recorded as the target of search. For example, a database in which current event information such as coverage data and article data generated by a medium that actually performs coverage and sends current event information such as a newspaper company is recorded may be the target of search.

The search target of the search unit 105A is not limited to the above-described examples. For example, the search unit 105A may set a database in which specialized and reliable information is recorded such as a specialized magazine in a field related to the content of the prompt as the target of search. Furthermore, the search unit 105A may set, for example, a database in which laws and regulations are recorded as the target of search. In addition, for example, the search unit 105A may set a database of an investigation company or the like that conducts a credibility investigation of a company as the target of search. Furthermore, the search unit 105A may detect information related to the prompt (may be current event information or other information) by crawling on the Internet.

In addition, a search method is also arbitrary. For example, the search unit 105A may extract a keyword included in the prompt and perform keyword search using the keyword. Furthermore, for example, the search unit 105A may convert a part or all of the prompt into a feature vector and detect information related to the prompt by vector search using the feature vector. Furthermore, for example, the search unit 105A may use both keyword search and vector search.

As described above, the information processing apparatus 1A includes the search unit 105A for detecting related current event information having a possibility of affecting the management environment of the target company from the database in which the current event information is recorded. Then, the generation control unit 103A adopts a configuration of inputting a prompt including the detected related current event information to the generative model to generate an answer. For this reason, according to the information processing apparatus 1A, in addition to the effects obtained by the information processing apparatus 1, an effect is obtained in that related current event information having a possibility of affecting the management environment of the target company among the current event information recorded in the database can be notified as a matter having a possibility of affecting the management environment of the target company. The number of databases to be searched may be one or plural.

### Example of Answer Generation

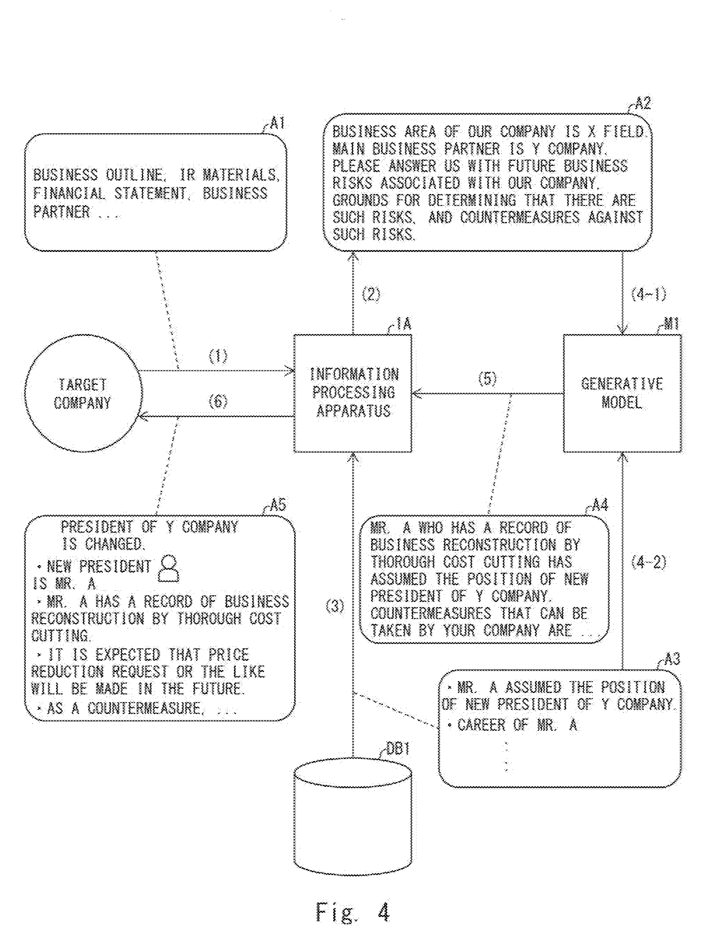

FIG. 4 is a diagram illustrating an example of notification by the information processing apparatus 1A. In the example of FIG. 4, as indicated by an arrow (1) in the figure, a target company that uses an information providing service by the information processing apparatus 1A inputs related information A1 including information such as a business outline, IR materials, financial statement, and business partners of the company to the information processing apparatus 1A. In the information providing service, it is also possible to input related information of other companies to notify the matter having a possibility of affecting the management environment of other companies.

The related information acquisition unit 101A of the information processing apparatus 1A acquires the related information A1 input by the target company and passes the related information A1 to the prompt generation unit 102A. Then, the prompt generation unit 102A generates a prompt inquiring about a matter having a possibility of affecting the management environment of the target company by using the related information A1. In the example of FIG. 4, as indicated by an arrow (2) in the figure, a prompt A2 that includes each piece of information extracted from the related information A1 and inquires about a business risk to be related in the future to the company specified by the information is generated.

The “business risk to be related in the future” described in the prompt A2 is an example of a matter having a possibility of affecting the management environment. It is also possible to replace the portion of “business risks to be related in the future” described in the prompt A2 with, for example, a description of “matter having a possibility of affecting the management environment”, “matter to be noted in the future in management”, or the like. The representation of the prompt A2 may be selected or modified by the target company.

In addition, the prompt A2 is a content instructing to answer, in addition to a business risk, ground for determining that there is a risk and a countermeasure against the risk. As a result, an answer including the ground and the countermeasure can be generated. For example, the prompt generation unit 102A can generate the prompt A2 by incorporating information extracted from the related information A1 into a template prepared in advance.

Next, on the basis of the prompt A2, the search unit 105A detects related current event information having a possibility of affecting the management environment of the target company from the DB1 that is a database in which the current event information is recorded. For example, the search unit 105A may convert the prompt A2 into a feature vector, perform vector search on the DB1 using the feature vector obtained by the conversion, and detect related current event information. In this case, it is desirable to record the feature vector of the current event information in the DB1 in association with each piece of current event information. In the example of FIG. 4, as indicated by an arrow (3) in the figure, the related current event information A3 related to “Y company” described in the related information A1 and the prompt A2 is detected.

Next, as indicated by arrows (4-1) and (4-2) in the figure, the generation control unit 103A inputs a prompt A2 including the related current event information A3 to the generative model M1 to generate an answer. In the example of FIG. 4, the answer A4 indicating that the fact that Mr. A has assumed the new president of Y company may be a business risk of the target company is generated based on the news that “Mr. A assumed the position of new president of Y company” and the “resume of Mr. A” described in the related current event information A3. In addition, the answer A4 also shows countermeasures against the risk. Then, as indicated by an arrow (5) in the figure, the information processing apparatus 1 acquires the generated answer A4. Although not illustrated in FIG. 4, the answer A4 also describes the grounds for determining that there is a risk (e.g., the above news detected from the DB1). Then, as indicated by an arrow (6) in the figure, the notification unit 104A notifies the target company of a notification screen A5 generated using the answer A4.

Upon generating the answer A4, the prompt generation unit 102A may generate a new prompt (a prompt instructing to answer with reference to the related current event information A3 in addition to content of the prompt A2) including the acquired related current event information A3. In addition, the prompt A2 may include a description instructing to answer with reference to the related current event information, and the related current event information A3 may be incorporated in the prompt A2 at the time point the related current event information A3 is acquired.

Here, the generative model M1 may include a conversion model for converting input data into a feature vector. For example, in a case where the generative model M1 is a model such as BERT, such a conversion model is included in the generative model M1. In this case, the search unit 105A may convert the prompt A2 into a feature vector using the conversion model included in the generative model M1, and perform vector search. Furthermore, in this case, the generation control unit 103A may input the feature vector generated for vector search by the search unit 105A to the generative model M1 instead of the prompt A2.

As described above, the prompt generation unit 102A may generate a prompt inquiring about a matter having a possibility of affecting the management environment of the target company, the prompt requesting to answer a countermeasure of the company with respect to the matter together with the matter. In this case, the notification unit 104A may notify the countermeasure of the target company with respect to the matter together with the matter indicated in the generated answer (matter having a possibility of affecting the management environment of the target company). As a result, in addition to the effects obtained by the information processing apparatus 1, an effect is obtained in that measures for a matter having a possibility of affecting the management environment can be supported.

### Example of Notification by Notification Screen

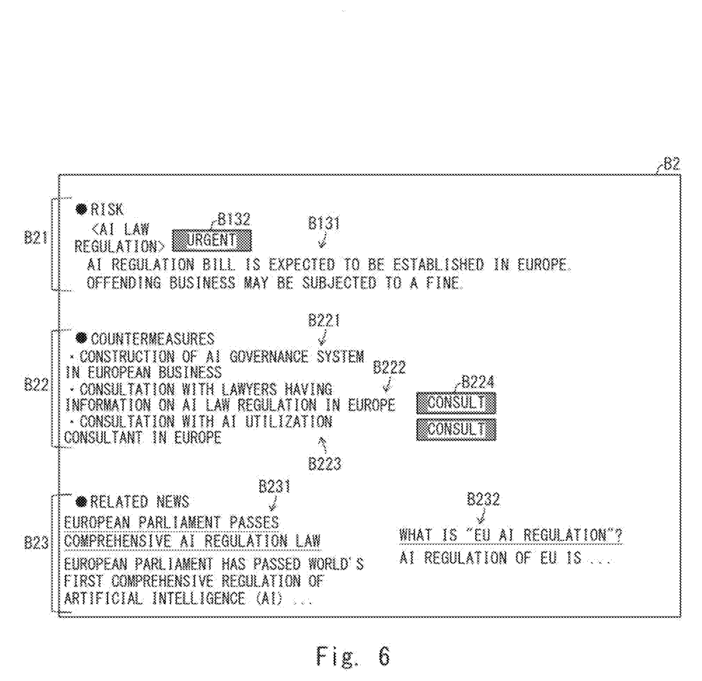

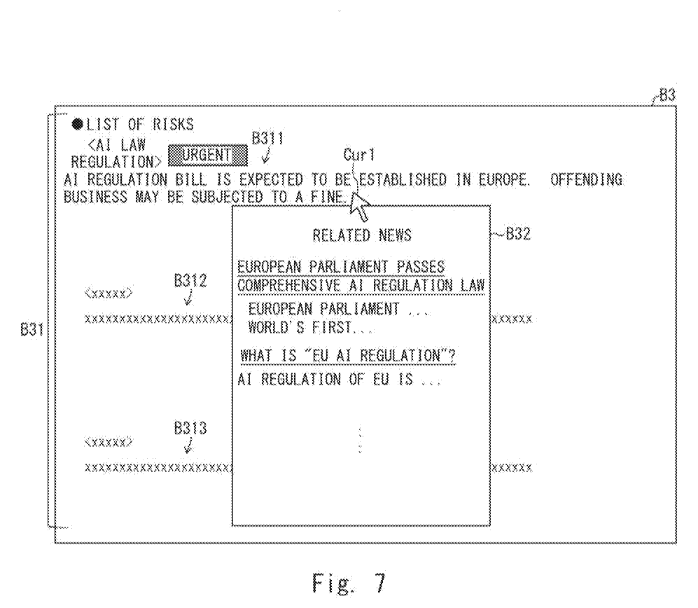

As described above, the notification unit 104A may perform notification by generating and displaying a predetermined notification screen using the generated answer. An example of notification by the notification screen will be described with reference to FIGS. 5-7. FIG. 5 is a diagram illustrating an example of a notification screen listing matters having a possibility of affecting the management environment of a target company. FIG. 6 is a diagram illustrating an example of a notification screen illustrating in detail matters having a possibility of affecting the management environment of the target company. In addition, FIG. 7 is a diagram illustrating a presentation example of related current event information on the notification screen. Such a notification screen can also be referred to as a report indicating matters having a possibility of affecting the management environment of the target company. That is, the notification unit 104A may generate a report indicating a matter having a possibility of affecting the management environment of the target company, and may notify the matter by transmitting the generated report to the user or making the report browsable by the user. The generation of the report may be executed by a processing unit other than the notification unit 104A, or the report generation unit may be provided in the control unit 10A and the generation of the report may be executed by the report generation unit, or the generation of the report may be executed by another apparatus different from the information processing apparatus 1A.

A notification screen B1 illustrated in FIG. 5 includes a graph B11 indicating a result of aggregating, by urgency, a plurality of matters having a possibility of affecting the management environment of the target company to be notified, and a graph B12 indicating a result of aggregating the plurality of matters by category. As described above, in a case where a plurality of matters are included in the answer generated by the generative model, the notification unit 104A may notify the result of analyzing these matters. The analysis may be performed by the notification unit 104A or another processing unit, or an analysis unit for performing analysis may be provided in the control unit 10A and the analysis may be performed by the analysis unit, or the analysis may be performed by another apparatus different from the information processing apparatus 1A. The content and method of the analysis are also arbitrary.

For example, analysis may be performed using a generative model. In this case, the prompt generation unit 102A may generate a prompt instructing to answer an analysis result of the matter in addition to the matter that affects the management environment. For example, the prompt generation unit 102A may generate a prompt inquiring about a matter having a possibility of affecting the management environment of the target company, the prompt requesting to answer the urgency or priority for notifying the matter together with the matter. As a result, since the urgency or priority of the matter is output from the generative model together with the matter having a possibility of affecting the management environment of the target company, the notification unit 104A can notify the analysis result of the urgency or priority in a mode such as, for example, a graph B11.

Furthermore, for example, the prompt generation unit 102A may generate a prompt inquiring about a matter having a possibility of affecting the management environment of the target company, the prompt requesting to answer a classification category of the matter together with the matter. As a result, since the classification category of the matter is output from the generative model together with the matter having a possibility of affecting the management environment of the target company, the notification unit 104A can notify the analysis result of the classification category in a mode such as, for example, a graph B12. The classification category may be freely output by the generative model, or candidates may be designated and one or a plurality of the candidates may be selected by the generative model.

In addition, for example, it is also possible to cause the generative model to generate the notification screen B1 by using a generative model machine-learned to generate content including image data and text data. In addition, it is also possible to generate the notification screen B1 by using a generative model for generating image data and a generative model for generating text data in combination.

In addition, the notification screen B1 illustrated in FIG. 5 includes a display region B13 that displays a list of business risks of the target company, that is, matters having a possibility of affecting the management environment of the target company. In the display region B13, a plurality of items including an item B131 with a title “AI law regulation” are displayed. The content displayed in each item is extracted from the answer generated by the generative model.

An emergency mark B132 is associated with the item B131. The emergency mark B132 indicates that the urgency of the item associated with this mark is high. As described above, since it is possible to analyze the urgency and priority of the matter having a possibility of affecting the management environment of the target company, it is also possible to present the analysis result to the user by such a mark.

In addition, in a case where a plurality of matters having a possibility of affecting the management environment of the target company are displayed in a list, the notification unit 104A may display the matters in order of urgency or priority of each item. As a result, it is possible to make matters having a high urgency or priority easily visible to the user.

As described above, in the information processing apparatus 1A, the prompt generation unit 102A may generate a prompt inquiring about a matter having a possibility of affecting the management environment of the target company, the prompt requesting to answer the urgency or priority for notifying the matter together with the matter. Then, the notification unit 104A may preferentially notify a matter having a high urgency or priority. Therefore, according to the information processing apparatus 1A, in addition to the effects obtained by the information processing apparatus 1, an effect is obtained in that the user can easily recognize a matter having a high urgency or priority.

Here, “preferentially notify” means that a matter having a higher urgency or priority is notified in such a way that the user can recognize it more easily than the matter having a lower urgency or priority. For example, the preferential notification can be performed by additionally displaying a mark such as an emergency mark B132 in FIG. 5, or can be performed in a mode of displaying in order of urgency or priority, or notifying only a matter with high urgency or priority.

Here, in a case where an operation of selecting an item is performed on any of the items displayed in the display region B13 of FIG. 5, the notification unit 104A may notify more detailed information regarding the selected item. FIG. 6 illustrates a notification screen B2 displayed at the time the item B131 in FIG. 5 is selected. The notification screen B2 includes three display regions (display regions B21 to B23) of risk, countermeasures, and related news. In the display region B21, an item B131 and an emergency mark B132 are displayed as in FIG. 5.

The display region B22 includes three items B221 to B223. Among them, in the item B221, a countermeasure included in the answer generated by the generative model is displayed. As described above, the notification unit 104A can notify the user of the countermeasure by extracting and displaying the matter described as the countermeasure in the answer generated by the generative model.

In the items B222 and B223, services related to the matter shown in the item B131 are displayed. These services are specified by the service specifying unit 106A. A consultation mark B224 is displayed in association with the items B222 and B223. The consultation mark B224 may be a link for making contact with a counter for using the related service.

The display region B23 includes items B231 and B232. These items indicate the grounds for notifying the matter indicated in item B131. More specifically, in the items B231 and B232, a news article that is related current event information input to the generative model at the time of answering the matter indicated in the item B131 is indicated. In a case where the operation of selecting the item B231 or B232 is performed, the entire news article may be displayed.

As described above, the information processing apparatus 1A includes the service specifying unit 106A for specifying a service related to the matter indicated in the answer generated by the generative model from among a plurality of predetermined services. Then, the notification unit 104A may notify the service specified by the service specifying unit 106A together with the matter indicated in the above answer. As a result, in addition to the effects obtained by the information processing apparatus 1, an effect can be obtained in that a service that is highly likely to meet the needs of the target company can be proposed.

Details of matters having a possibility of affecting the management environment of the target company and a display mode of matters related to the matters (grounds, countermeasures, related services, etc.) are arbitrary, and are not limited to the mode as in the example of FIG. 6. For example, the notification unit 104A may notify a matter having a possibility of affecting the management environment of the target company by displaying the matter, and may display related current event information in accordance with a predetermined operation on the displayed description portion of the matter. As a result, in addition to the effects obtained by the information processing apparatus 1, an effect is obtained in that the related current event information can be confirmed by a simple and intuitive operation.

FIG. 7 illustrates an example in which related current event information is displayed in accordance with a predetermined operation on a description portion of a matter having a possibility of affecting the management environment of the target company. The notification screen B3 illustrated in FIG. 7 includes a display region B31 that displays a list of business risks of the target company, that is, matters having a possibility of affecting the management environment of the target company.

The display region B31 includes three items B311 to B313, and a cursor Cur1 is positioned at an item 311, that is one of the three items. That is, the “predetermined operation” in the example of FIG. 7 is an operation of positioning the cursor Cur1 at a description portion of a matter having a possibility of affecting the management environment of the target company. In the example of FIG. 7, in response to this operation, a pop-up screen B32 indicating related news related to the matter of item 311, that is, related current event information is displayed. A countermeasure or a related service may be presented by a similar operation.

### Addition of Related Information

The related information acquisition unit 101A may acquire, after a matter having a possibility of affecting the management environment of the target company has been notified by the notification unit 104A, additional related information related to the notified matter. Then, the generation control unit 103A may input a prompt including the additional related information into the generative model to generate an answer, and the notification unit 104A may notify a matter having a possibility of affecting the management environment of the target company based on the answer to the prompt including the additional related information. As a result, in addition to the effect obtained by the information processing apparatus 1, an effect is obtained in that a more accurate notification can be performed based on additional related information based on the previously notified matter.

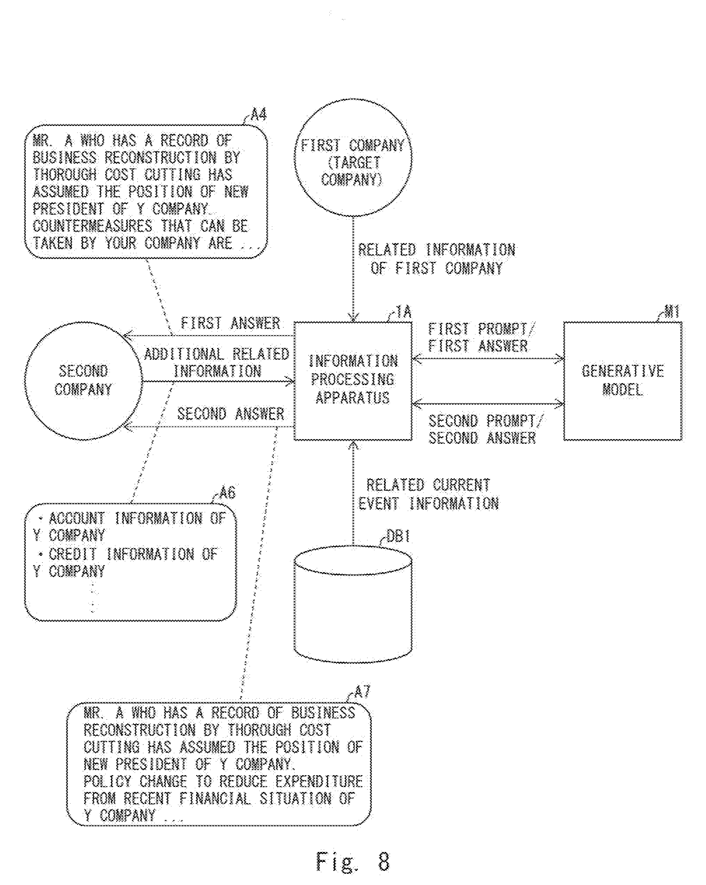

FIG. 8 is a diagram illustrating an example of answer generation using additional related information. In the example of FIG. 8, two companies, a first company and a second company, are involved. The first company is a target company and the second company is a company holding various types of information about the target company and/or another company related to the target company. For example, the second company may be a financial institution such as a bank that intends to offer a loan to the first company. In this case, the financial institution, that is the second company, is capable of conducting business operations with respect to the first company by considering a business risk of the first company notified by the information processing apparatus 1A, considering in advance a consultation plan or a loan proposal for eliminating such a risk, and proposing the consultation plan or the loan proposal.

In the example of FIG. 8 as well, similarly to the example of FIG. 4, related information of the first company, that is, the target company is input to the information processing apparatus 1A. The related information of the target company may be input by the first company that is the target company or may be input by the second company. Then, the related current event information is detected by searching the DB1, and the first prompt including the related current event information is input to the generative model M1, and the first answer is generated. In the example of FIG. 8, an answer A4 similar to that in the example of FIG. 4 (an answer indicating that the president of the main business partner of the target company has changed) is generated as the first answer.

In the example of FIG. 8, the generated first answer A4 is notified to the second company. Then, after confirming the first answer, the second company inputs information related to the first answer to the information processing apparatus 1A as additional related information A6. Specifically, the account information and the credit information of “Y company” described in the first answer A4 are input as the additional related information A6. The account information includes, for example, deposit/withdrawal information to the account, a loan history, a repayment history, and the like. In addition, for example, Customer Relationship Management (CRM) information or the like can be used as the additional related information A6.

In the information processing apparatus 1A, the related information acquisition unit 101A acquires the additional related information A6 input by the second company. Subsequently, the prompt generation unit 102A generates a second prompt (similar to the first prompt, a prompt inquiring about a matter having a possibility of affecting the management environment of the target company) by using the additional related information A6. At this time, the related current event information used for generating the first answer may also be included in the second prompt. Then, the generation control unit 103A inputs the generated second prompt to the generative model M1 to generate an answer. The second answer A7 generated in this manner and notified to the second company by the notification unit 104A indicates a more detailed analysis result than the first answer A4 since the additional related information A6 is reflected.

### Flow of Processing

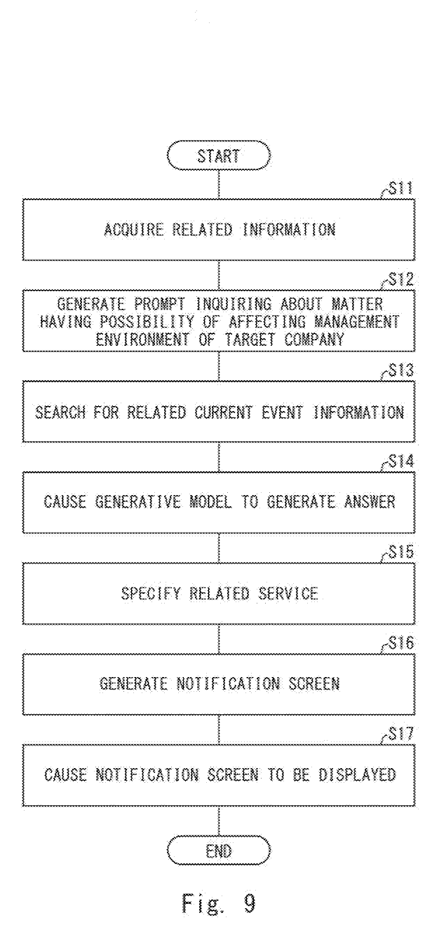

A flow of the processing executed by the information processing apparatus 1A will be described with reference to FIG. 9. FIG. 9 is a flowchart illustrating the flow of the processing executed by the information processing apparatus 1A. The flowchart of FIG. 9 includes each processing of the notification method according to the present exemplary example embodiment.

In S11 (related information acquisition processing), the related information acquisition unit 101A acquires related information related to the target company. For example, the related information acquisition unit 101A may acquire the related information input to the terminal device operated by the user of the information providing service via the communication unit 12A. Furthermore, for example, the related information acquisition unit 101A may acquire the related information input by the user of the information providing service via the input unit 13A.

In S12 (prompt generation processing), the prompt generation unit 102A generates a prompt inquiring about a matter having a possibility of affecting the management environment of the target company by using the related information acquired in S11. This prompt may inquire about at least any of the urgency or priority of notifying the matter, the countermeasure against the matter, and the grounds for notifying the matter.

In S13, the search unit 105A searches for related current event information having a possibility of affecting the management environment of the target company using the prompt generated in S12. In S12, information other than the current event information may also be set as the search target. In addition, the search unit 105A may search for the related current event information using the related information acquired in S11. In this case, the search may be performed after S11 and before S12, and in S12, the prompt may be generated using the related information acquired in S11 and the related current event information detected by the search.

In S14 (generation control processing), the generation control unit 103A inputs a prompt inquiring about a matter having a possibility of affecting the management environment of the target company, the prompt including the related current event information detected in S13, to the machine-learned generative model to generate an answer. In performing the processing of S14, the prompt generation unit 102A may regenerate the prompt by using the related current event information detected in S13. In addition, the generation control unit 103A may incorporate the related current event information detected in S13 into the prompt generated in S12 and input the prompt into the generative model.

In S15, the service specifying unit 106A specifies a service related to the matter indicated in the answer generated in S14.

In S16, the notification unit 104A generates a notification screen for notifying a matter having a possibility of affecting the management environment of the target company based on the answer generated in S14. To be precise, the notification unit 104A generates image data for displaying the notification screen. In addition to the answer generated in S14, the related current event information detected in S13, information indicating the service specified in S15, and the like may be included in the notification screen. As described with reference to FIGS. 5-7, the related current event information, the service, and the like may be displayed according to the operation of the user.

In S17 (notification processing), the notification unit 104A displays the notification screen generated in S16. As a result, a matter having a possibility of affecting the management environment of the target company is notified, and the processing of FIG. 9 ends.

As in the example of FIG. 8, the input of the additional related information may be accepted after S17. In this case, after the additional related information is acquired, a prompt including the additional related information is generated, the generated prompt is input into the generative model, a new answer is generated, and the generated new answer is notified.

### Monitoring of Management Environment

The information processing apparatus 1A can be suitably used for monitoring the management environment. In this case, the search unit 105A searches for the related current event information every time a predetermined search timing arrives. Here, in a case where the new related current event information is detected by the search unit 105A, the prompt generation unit 102A generates a new prompt inquiring about a matter having a possibility of affecting the management environment of the target company by using the new related current event information. Then, the generation control unit 103A inputs the generated new prompt to the generative model to generate a new answer, and the notification unit 104A notifies a matter having a possibility of affecting the management environment of the target company based on the generated new answer. As a result, in addition to the effects obtained by the information processing apparatus 1, an effect is obtained in that continuous monitoring of the related current event information having a possibility of affecting the management environment of the target company can be easily performed. This also makes it possible to immediately alert a change in the external environment of the target company.

It is desirable to record the latest news and the like as needed also in the database serving as the search target of the search unit 105A in such a way that the notification reflecting the latest news and the like is performed. Furthermore, it is also effective to include a web page such as a news site on which the latest news and topics are posted in the search target of the search unit 105A.

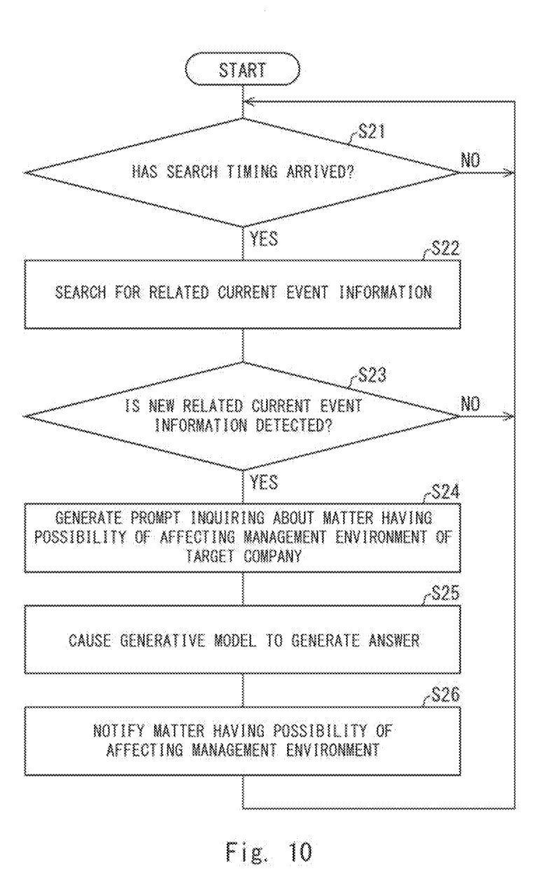

FIG. 10 is a flowchart of processing related to monitoring of the management environment. The processing of FIG. 10 is performed, for example, after the execution of the processing of FIG. 9 is completed.

In S21, the search unit 105A determines whether a predetermined search timing has arrived. In a case where determination is made as YES in S21, the processing proceeds to S22, and in a case where determination is made as NO in S21, the processing of S21 is performed again after a predetermined time. The search timing may be determined in advance. For example, the timing at which the database serving as the search target of the search unit 105A is updated may be set as the search timing, or the timing at which a predetermined period (e.g., one day) has elapsed from the previous search may be set as the search timing.

In S22, the search unit 105A searches for the related current event information. The search of the related current event information may be performed in the same manner as in S13 of FIG. 9. Even if the search method and the search condition are the same as those of the previous search, if the database or the like serving as the search target of the search unit 105A is updated, new related current event information can be detected. In the second and subsequent searches, the search condition may be changed from the previous search.

In S23, the search unit 105A determines whether new related current event information has been detected by the search in S22. The new related current event information is related current event information that has not been detected in the previous search. In a case where determination is made as YES in S23, the processing proceeds to S24. On the other hand, in a case where determination is made as NO in S23, the processing returns to S21.

In S24, the prompt generation unit 102A generates a new prompt inquiring about a matter having a possibility of affecting the management environment of the target company by using the new related current event information detected by the search in S22. For example, the prompt generation unit 102A may generate a prompt that includes new related current event information detected by the search in S22 and related information of the target company acquired beforehand (e.g., in S11 in FIG. 9), and instructs to explain a matter having a possibility of affecting the management environment of the target company specified by the related information with reference to the new related current event information.

In S25, the generation control unit 103A inputs the new prompt generated in S24 to the generative model and generates a new answer. Then, in S26, the notification unit 104A notifies a matter having a possibility of affecting the management environment of the target company based on the generated new answer. Thereafter, the processing returns to S21.

A mode of notification in S25 is arbitrary, and for example, the notification may be performed by generating a notification screen and displaying the generated notification screen, similarly to the flowchart of FIG. 9. In this case, the operation of displaying the generated notification screen may be performed by the user. Furthermore, the notification in S25 may be performed by e-mail or the like.

### Modified Examples

An executing entity of each processing described in the above-described exemplary example embodiments is optional, and is not limited to the above-described examples. For example, a system having functions similar to those of the information processing apparatuses 1 and 1A can be constructed by a plurality of apparatuses capable of communicating with each other. The executing entity of each processing illustrated in each of the flowcharts illustrated in FIGS. 9 and 10 may be one device (also referred to as a processor) or a plurality of apparatuses (also referred to as processors).

### Implementation Example by Software

Some or all of the functions of the information processing apparatuses 1 and 1A (hereinafter, also referred to as “each of the above apparatuses”) may be implemented by hardware such as an integrated circuit (IC chip) or may be implemented by software.

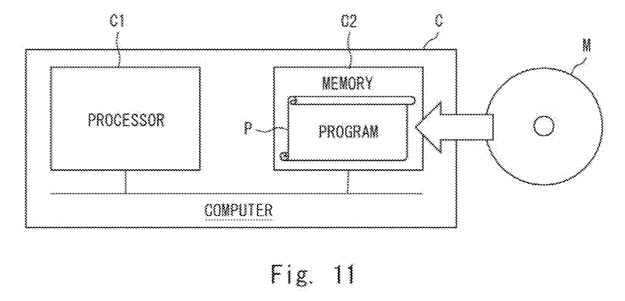

In the latter case, each of the above apparatuses is achieved by, for example, a computer that executes commands of a program that is software for achieving each function. An example of such a computer (hereinafter referred to as a computer C) is illustrated in FIG. 11. FIG. 11 is a block diagram illustrating a hardware configuration of the computer C that functions as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information

The present disclosure includes the techniques described in the following Supplementary Notes. However, the present disclosure is not limited to the technologies described in the following Supplementary Notes, and various modifications can be made within the scope described in the claims.

### Supplementary Note A1

An information processing apparatus including a related information acquisition means for acquiring related information related to a company to be a target, a prompt generation means for generating a prompt inquiring about a matter having a possibility of affecting a management environment of the company by using the related information, a generation control means for inputting the prompt to a machine-learned generative model to generate an answer, and a notification means for notifying a matter having a possibility of affecting the management environment of the company based on the answer.

### Supplementary Note A2

The information processing apparatus according to supplementary note A1, further including a search means for detecting related current event information having a possibility of affecting a management environment of the company from a database in which current event information is recorded, in which the generation control means inputs a prompt including the related current event information to the generative model to generate an answer.

### Supplementary Note A3

The information processing apparatus according to supplementary note A2, in which the search means performs a search for the related current event information every time a predetermined search timing arrives, the prompt generation means generates, in a case where new related current event information is detected by the search means, a new prompt inquiring about a matter having a possibility of affecting the management environment of the company by using the new related current event information, the generation control means inputs the new prompt to the generative model to generate a new answer, and the notification means notifies about the matter having a possibility of affecting the management environment of the company based on the new answer.

### Supplementary Note A4

The information processing apparatus according to supplementary note A2 or A3, in which the notification means notifies a matter having a possibility of affecting the management environment of the company by displaying the matter, and causes the related current event information to be displayed according to a predetermined operation on a description portion of the displayed matter.

### Supplementary Note A5

The information processing apparatus according to any one of supplementary notes A1 to A4, in which the prompt generation means generates a prompt inquiring about a matter having a possibility of affecting the management environment of the company, the prompt requesting to answer urgency or priority of notifying the matter together with the matter, and the notification means preferentially notifies the matter of which urgency or priority is high.

### Supplementary Note A6

The information processing apparatus according to any one of supplementary notes A1 to A5, in which the prompt generation means generates a prompt inquiring about a matter having a possibility of affecting a management environment of the company, the prompt requesting to answer a countermeasure of the company with respect to the matter together with the matter, and the notification means notifies the countermeasure of the company with respect to the matter together with the matter indicated in the answer.

### Supplementary Note A7

The information processing apparatus according to any one of supplementary notes A1 to A6, further including a service specifying means for specifying a service related to the matter indicated in the answer from among a plurality of predetermined services, in which the notification means notifies the service specified by the service specifying means together with the matter indicated in the answer.

### Supplementary Note A8

The information processing apparatus according to any one of supplementary notes A1 to A7, in which the related information acquisition means acquires additional related information related to the notified matter, the generation control means inputs a prompt including the additional related information to the generative model to generate an answer, and the notification means notifies about a matter having a possibility of affecting the management environment of the company based on the answer to the prompt including the additional related information.

### Supplementary Note B1

A notification method, by at least one processor, including related information acquisition processing of acquiring related information related to a company to be a target, prompt generation processing of generating a prompt inquiring about a matter having a possibility of affecting a management environment of the company by using the related information, generation control processing of inputting the prompt to a machine-learned generative model to generate an answer, and notification processing of notifying a matter having a possibility of affecting the management environment of the company based on the answer.

### Supplementary Note B2

The notification method according to supplementary note B1, in which the at least one processor includes search processing of detecting related current event information having a possibility of affecting a management environment of the company from a database in which current event information is recorded, and in the generation control processing, the at least one processor inputs a prompt including the related current event information to the generative model to generate an answer.

### Supplementary Note B3

The notification method according to supplementary note B2, in which the at least one processor performs a search for the related current event information every time a predetermined search timing arrives, and in a case where the new related current event information is detected, generates a new prompt inquiring about a matter having a possibility of affecting the management environment of the company by using the new related current event information, inputs the new prompt to the generative model to generate a new answer, and notifies the matter having a possibility of affecting the management environment of the company based on the new answer.

### Supplementary Note B4

The notification method according to supplementary note B2 or B3, in which in the notification processing, the at least one processor notifies a matter having a possibility of affecting the management environment of the company by displaying the matter, and causes the related current event information to be displayed according to a predetermined operation on a description portion of the displayed matter.

### Supplementary Note B5

The notification method according to any one of supplementary notes B1 to B4, in which in the prompt generation processing, the at least one processor generates a prompt inquiring about a matter having a possibility of affecting the management environment of the company, the prompt requesting to answer urgency or priority of notifying the matter together with the matter, and in the notification processing, the at least one processor preferentially notifies the matter of which urgency or priority is high.

### Supplementary Note B6

The notification method according to any one of supplementary notes B1 to B5, in which in the prompt generation processing, the at least one processor generates a prompt inquiring about a matter having a possibility of affecting the management environment of the company, the prompt requesting to answer a countermeasure of the company with respect to the matter together with the matter, and the at least one processor notifies the countermeasure of the company with respect to the matter together with the matter indicated in the answer.

### Supplementary Note B7

The notification method according to any one of supplementary notes B1 to B6, in which the at least one processor includes service specifying processing of specifying a service related to the matter indicated in the answer from a plurality of predetermined services, and in the notification processing, the at least one processor notifies the service specified by the service specifying processing together with the matter indicated in the answer.

### Supplementary Note B8

The notification method according to any one of supplementary notes B1 to B7, in which in the related information acquisition processing, the at least one processor acquires additional related information related to the notified matter, in the generation control processing, the at least one processor inputs a prompt including the additional related information to the generative model to generate an answer, and in the notification processing, the at least one processor notifies a matter having a possibility of affecting the management environment of the company based on the answer to the prompt including the additional related information.

### Supplementary Note C1

A notification program for causing a computer to function as a related information acquisition means for acquiring related information related to a company to be a target, a prompt generation means for generating a prompt inquiring about a matter having a possibility of affecting a management environment of the company by using the related information, a generation control means for inputting the prompt to a machine-learned generative model to generate an answer, and a notification means for notifying a matter having a possibility of affecting the management environment of the company based on the answer.

### Supplementary Note C2

The notification program according to supplementary note C1, further causing the computer to function as a search means for detecting related current event information having a possibility of affecting a management environment of the company from a database in which current event information is recorded, in which the generation control means inputs a prompt including the related current event information to the generative model to generate an answer.

### Supplementary Note C3

The notification program according to supplementary note C2, in which the search means performs a search for the related current event information every time a predetermined search timing arrives, the prompt generation means generates, in a case where new related current event information is detected by the search means, a new prompt inquiring about a matter having a possibility of affecting the management environment of the company by using the new related current event information, the generation control means inputs the new prompt to the generative model to generate a new answer, and the notification means notifies the matter having a possibility of affecting the management environment of the company based on the new answer.

### Supplementary Note C4

The notification program according to supplementary note C2 or C3, in which the notification means notifies a matter having a possibility of affecting the management environment of the company by displaying the matter, and causes the related current event information to be displayed according to a predetermined operation on a description portion of the displayed matter.

### Supplementary Note C5

The notification program according to any one of supplementary notes C1 to C4, in which the prompt generation means generates a prompt inquiring about a matter having a possibility of affecting the management environment of the company, the prompt requesting to answer urgency or priority of notifying the matter together with the matter, and the notification means preferentially notifies the matter of which urgency or priority is high.

### Supplementary Note C6

The notification program according to any one of supplementary notes C1 to C5, in which the prompt generation means generates a prompt inquiring about a matter having a possibility of affecting a management environment of the company, the prompt requesting to answer a countermeasure of the company with respect to the matter together with the matter, and the notification means notifies the countermeasure of the company with respect to the matter together with the matter indicated in the answer.

### Supplementary Note C7

The notification program according to any one of supplementary notes C1 to C6, further causing the computer to function as a service specifying means for specifying a service related to the matter indicated in the answer from among a plurality of predetermined services, in which the notification means notifies the service specified by the service specifying means together with the matter indicated in the answer.

### Supplementary Note C8

The notification program according to any one of supplementary notes C1 to C7, in which the related information acquisition means acquires additional related information related to the notified matter, the generation control means inputs a prompt including the additional related information to the generative model to generate an answer, and the notification means notifies about a matter having a possibility of affecting the management environment of the company based on the answer to the prompt including the additional related information.

### Supplementary Note D1

An information processing apparatus including at least one processor, in which the at least one processor executes related information acquisition processing of acquiring related information related to a company to be a target, prompt generation processing of generating a prompt inquiring about a matter having a possibility of affecting a management environment of the company by using the related information, generation control processing of inputting the prompt to a machine-learned generative model to generate an answer, and notification processing of notifying a matter having a possibility of affecting the management environment of the company based on the answer.

The information processing apparatus may further include a memory. The memory may store a program for causing the at least one processor to execute the pieces of processing.

### Supplementary Note D2

The information processing apparatus according to supplementary note D1, in which the at least one processor executes search processing of detecting related current event information having a possibility of affecting a management environment of the company from a database in which current event information is recorded, and in the generation control processing, the at least one processor inputs a prompt including the related current event information to the generative model to generate an answer.

### Supplementary Note D3

The information processing apparatus according to supplementary note D2, in which the at least one processor performs a search for the related current event information every time a predetermined search timing arrives, and in a case where the new related current event information is detected, generates a new prompt inquiring about a matter having a possibility of affecting the management environment of the company by using the new related current event information, inputs the new prompt to the generative model to generate a new answer, and notifies the matter having a possibility of affecting the management environment of the company based on the new answer.

### Supplementary Note D4

The information processing apparatus according to supplementary note D2 or D3, in which in the notification processing, the at least one processor notifies a matter having a possibility of affecting the management environment of the company by displaying the matter, and causes the related current event information to be displayed according to a predetermined operation on a description portion of the displayed matter.

### Supplementary Note D5

The information processing apparatus according to any one of supplementary notes D1 to D4, in which in the prompt generation processing, the at least one processor generates a prompt inquiring about a matter having a possibility of affecting the management environment of the company, the prompt requesting to answer urgency or priority of notifying the matter together with the matter, and in the notification processing, the at least one processor preferentially notifies the matter of which urgency or priority is high.

### Supplementary Note D6

The information processing apparatus according to any one of supplementary notes D1 to D5, in which in the prompt generation processing, the at least one processor generates a prompt inquiring about a matter having a possibility of affecting the management environment of the company, the prompt requesting to answer a countermeasure of the company with respect to the matter together with the matter, and in the notification processing, the at least one processor notifies the countermeasure of the company with respect to the matter together with the matter indicated in the answer.

### Supplementary Note D7

The information processing apparatus according to any one of supplementary notes D1 to D6, in which the at least one processor includes service specifying processing of specifying a service related to the matter indicated in the answer from a plurality of predetermined services, and in the notification processing, the at least one processor notifies the service specified by the service specifying processing together with the matter indicated in the answer.

### Supplementary Note D8

The information processing apparatus according to any one of supplementary notes D1 to D7, in which the at least one processor acquires additional related information related to the notified matter, inputs a prompt including the additional related information to the generative model to generate an answer, and notifies about a matter having a possibility of affecting the management environment of the company based on the answer to the prompt including the additional related information.

### Supplementary Note E

A non-transitory recording medium recorded with a notification program for causing a computer to execute related information acquisition processing of acquiring related information related to a company to be a target, prompt generation processing of generating a prompt inquiring about a matter having a possibility of affecting a management environment of the company by using the related information, generation control processing of inputting the prompt to a machine-learned generative model to generate an answer, and notification processing of notifying a matter having a possibility of affecting the management environment of the company based on the answer.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one storage medium configured to store instructions; and
at least one processor configured to execute the instructions to:
acquire related information related to a company to be a target;
generate a prompt inquiring about a matter having a possibility of affecting a management environment of the company by using the related information;
input the prompt to a machine-learned generative model to generate an answer, and
notify a matter having a possibility of affecting the management environment of the company based on the answer.

2. The information processing apparatus according to claim 1, wherein the at least one processor is further configured to execute the instructions to:
detect related current event information having a possibility of affecting a management environment of the company from a database in which current event information is recorded,
input a prompt including the related current event information to the generative model to generate the answer.

3. The information processing apparatus according to claim 2, wherein the at least one processor is further configured to execute the instructions to:
perform a search for the related current event information every time a predetermined search timing arrives,
generate, in a case where new related current event information is detected, a new prompt inquiring about a matter having a possibility of affecting the management environment of the company by using the new related current event information,
input the new prompt to the generative model to generate a new answer, and
notify the matter having a possibility of affecting the management environment of the company based on the new answer.

4. The information processing apparatus according to claim 2, wherein the at least one processor is further configured to execute the instructions to:
notify a matter having a possibility of affecting the management environment of the company by displaying the matter, and cause the related current event information to be displayed according to a predetermined operation on a description portion of the displayed matter.

5. The information processing apparatus according to claim 1, wherein the at least one processor is further configured to execute the instructions to:
generate a prompt inquiring about a matter having a possibility of affecting the management environment of the company, the prompt requesting to answer urgency or priority of notifying the matter together with the matter, and
preferentially notify the matter of which urgency or priority is high.

6. The information processing apparatus according to claim 1, wherein the at least one processor is further configured to execute the instructions to:
generate a prompt inquiring about a matter having a possibility of affecting a management environment of the company, the prompt requesting to answer a countermeasure of the company with respect to the matter together with the matter, and
notify the countermeasure of the company with respect to the matter together with the matter indicated in the answer.

7. The information processing apparatus according to claim 1, wherein the at least one processor is further configured to execute the instructions to:
specify a service related to the matter indicated in the answer from among a plurality of predetermined services,
notify the specified service together with the matter indicated in the answer.

8. The information processing apparatus according to claim 1, wherein the at least one processor is further configured to execute the instructions to:
acquire additional related information related to the notified matter,
input a prompt including the additional related information to the generative model to generate an answer, and
notify about a matter having a possibility of affecting the management environment of the company based on the answer to the prompt including the additional related information.

9. A notification method, by at least one processor, comprising:
related information acquisition processing of acquiring related information related to a company to be a target;
prompt generation processing of generating a prompt inquiring about a matter having a possibility of affecting a management environment of the company by using the related information;
generation control processing of inputting the prompt to a machine-learned generative model to generate an answer; and
notification processing of notifying a matter having a possibility of affecting the management environment of the company based on the answer.

10. A non-transitory computer-readable medium stored with a notification program for causing a computer to perform a process comprising:
acquiring related information related to a company to be a target;
generating a prompt inquiring about a matter having a possibility of affecting a management environment of the company by using the related information;
inputting the prompt to a machine-learned generative model to generate an answer; and
notifying a matter having a possibility of affecting the management environment of the company based on the answer.
